(19) United States
(12) Patent Application Publication
(10) Pub. No.: US 2018/0225786 A1
(43) Pub. Date: Aug. 9, 2018

(54) Process And System For Conducting A Post Listing Inspection Of Real Estate Property

(71) Applicant: Damian Salas, Springfield, PA (US)

(72) Inventor: Damian Salas, Springfield, PA (US)

(73) Assignee: Inovas Group, LLC, Springfield, PA (US)

(21) Appl. No.: 15/893,571

(22) Filed: Feb. 9, 2018

Related U.S. Application Data
(60) Provisional application No. 62/457,154, filed on Feb. 9, 2017.

(51) Int. Cl. G06Q 50/16

(52) U.S. Cl. CPC G06Q 50/167; G06Q 50/163

(57) ABSTRACT

The present invention is generally related to real estate transactions, and more particularly related to processes and systems for conducting a post listing inspection of a seller's real estate property after the real estate property has been listed for sale but prior to a buyer entering into a contract for sale with the seller. The disclosed processes, and systems for carrying out the processes, provide many benefits to real estate buyers, real estate sellers, real estate agents, and the home inspectors themselves. For example, deficiencies in the real estate property can be discovered early and disclosed to the seller early, so that repairs may be made or planned and the qualified opinion of the home inspector as to the condition of the real estate property can be taken into account during negotiations over the sale price of the real estate property.

### CROSS-REFERENCES TO RELATED APPLICATIONS

This non-provisional utility application takes priority to the previously filed provisional application: Application No. 62/457,154, filed Feb. 9, 2017, which is hereby incorporated in its entirety by reference.

### BRIEF DESCRIPTION OF THE INVENTION

The present invention is generally related to real estate transactions, and more particularly related to processes and systems for conducting a post listing inspection of a seller's real estate property after the real estate property has been listed for sale but prior to a buyer entering into a contract for sale with the seller. The disclosed processes, and systems for carrying out the processes, provide many benefits to real estate buyers, real estate sellers, real estate agents, and the home inspectors themselves.

An exemplary embodiment of the herein disclosed process for transferring a real estate property from a seller to a buyer may comprise the steps of: listing the real estate property for sale; having a home inspection carried out by a home inspector, wherein the home inspector is paid by the seller; receiving a home inspection report from the home inspector; presenting the home inspection report to the seller; facilitating conversation between the seller and the home inspector; reporting one or more completed repairs to the home inspector; receiving a revised home inspection report from the home inspector; presenting the revised home inspection report to one or more prospective buyers; negotiated a contract for sale with the buyer; and executing the contract for sale with the buyer.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION

A real estate transaction process is a process for transferring property rights from a conveying party to receiving party. The conveying party may also be referred to as a seller or as an owner. The receiving party may also be referred to as a buyer. This real estate transaction process can be complex because it may involve many steps, including listing the real estate property for sale, inspecting the real estate property, and settling on an agreement between the conveying party and the receiving party. Most real estate transaction processes involve several third parties beyond the conveying party, which may include one or more real estate agents, one or more financial institutions, one or more title companies, and one or more attorneys.

For most real estate transaction processes, the step of listing the real estate property for sale includes a step of agreeing to a listing agreement. The listing agreement is a legal contract, between the conveying party (owner of the real estate property) and the conveying party's real estate agent, that may state a sale price, a commission rate to be paid to the one or more real estate agents, and a length of time for the real estate property to remain on the market.

Determining the sale price can be complicated and may involve balancing one or more of several factors. One factor that has a significant impact on determining the sale price is the condition of the real estate property. But the seller's real estate agent is usually, or often, unqualified to offer an opinion as to the real estate property condition. This can be a problem for the step of determining a sale price for the real estate property.

Current solutions to this issue of the seller's real estate agent being unable to offer a qualified opinion as to the condition of the real estate property involve hiring a qualified independent home inspector to inspect the real estate property and to provide a qualified opinion as to the real estate property condition. There are two methods in use today for inspecting real estate properties: (1) a pre-listing home inspection, taking place before the seller's real estate agent and the seller determine a sale price and agree to a listing agreement; or (2) a home inspection carried out after a contract for sale has been fully executed (after the step of settling on an agreement between the seller and the buyer).

A home inspection carried out after a contract for sale has been fully executed is common in the real estate industry, and has been the norm for many years. But there are many problems with this process. Using this common process, the home inspection does not occur until after the contract price has been negotiated between the seller and the buyer and after all the contracts (including the contract for sale) have been signed by both transaction parties. The buyer includes a standard “inspection clause” in the contract for sale, the buyer pays for this inspection (a “buyer's inspection”), and the possible scope of the inspection is virtually unlimited. For example, this buyer's inspection may include everything from systems such as heating, cooling, plumbing, and electrical, to appliances, pealing paint, and mismatched outlet colors. When real estate property deficiencies are not discovered until this buyer's inspection, the buyer can require that all deficiencies be cured or repaired, and that all such repairs be done by a licensed contractor, no matter how simple. This leads to a high, and sometimes unexpected, cost for fixing buyer's inspection deficiencies. If the seller refuses to honor the buyer's requests based upon the buyer's inspection, the buyer then has the right to cancel the contract for sale of the real estate property.

A pre-listing home inspection (which may be referred to as a “seller's inspection” in the real estate industry) is a relatively new service in the real estate industry and is not yet widely used. The advantages of the pre-listing home inspection are that this service may help to eliminate some of the issues associated with waiting to do the home inspection until after a buyer has agreed to a contract of sale. A pre-listing home inspection is paid for by the seller (the conveying party), usually before the real estate property goes on the market. This means that the home inspector is now working for the seller, as opposed to working for the buyer. This pre-listing home inspection process leads to a decrease in surprising and expensive repairs after the contract for sale has been negotiated and agreed to between the seller and the buyer. And the pre-listing home inspection leads to determining a more accurate listing price for the listing agreement between the seller and the seller's real estate agent, because a qualified opinion as to the condition of the real estate property has been taken into account. But a major disadvantage to such a pre-listing home inspection is that it is completed before the real estate property is listed for sale, and therefore the entire real estate transaction process is significantly delayed from the outset. Furthermore, the seller's real estate agent may have to engage in a difficult conversation with the seller about the condition of the real estate property, and about making repairs before the property can even be listed for sale.

There is a need for an alternative real estate transaction process that addresses the known drawbacks to both buyer's inspections (completed after the contract for sale is entered into between the seller and the buyer) and pre-listing inspections (completed before the real estate property is listed for sale). The present invention provides a post-listing, but pre contract for sale, home inspection that addresses these needs and is a useful improvement on the real estate transaction processes currently used in the real estate industry.

### BRIEF DESCRIPTION OF THE SEVERAL VIEWS OF THE DRAWING

FIG. 1 is a schematic flowchart of a process for transferring a real estate property from a seller to a buyer, in accordance with an exemplary embodiment of the present invention;

FIG. 2 is a schematic flowchart of an alternative embodiment of the herein disclosed process which may alternatively be referred to as a process for conducting a post listing inspection of real estate property, in accordance with the present invention; and

FIG. 3 illustrates an exemplary embodiment of a system for transferring a real estate property from a seller to a buyer, in accordance with the present invention.

### DETAILED DESCRIPTION OF THE INVENTION

The present invention is generally related to real estate transactions, and more particularly related to processes and systems for conducting a post listing inspection of a seller's real estate property after the real estate property has been listed for sale but prior to a buyer entering into a contract for sale with the seller.

An exemplary embodiment of the herein disclosed process for transferring a real estate property from a seller to a buyer may comprise the steps of: listing the real estate property for sale; having a home inspection carried out by a home inspector, wherein the home inspector is paid by the seller; receiving a home inspection report from the home inspector; presenting the home inspection report to the seller; facilitating conversation between the seller and the home inspector; reporting one or more completed repairs to the home inspector; receiving a revised home inspection report from the home inspector; presenting the revised home inspection report to one or more prospective buyers; negotiated a contract for sale with the buyer; and executing the contract for sale with the buyer. This process may be referred to as a process for conducting a post listing inspection of real estate property. The process for transferring a real estate property, and alternative embodiments of the herein disclosed processes, may be carried out by a system for transferring a real estate property from a seller to a buyer comprising a website, a computer system, a mobile application, or an alternative digital structure for automating one or more of the herein disclosed process steps.

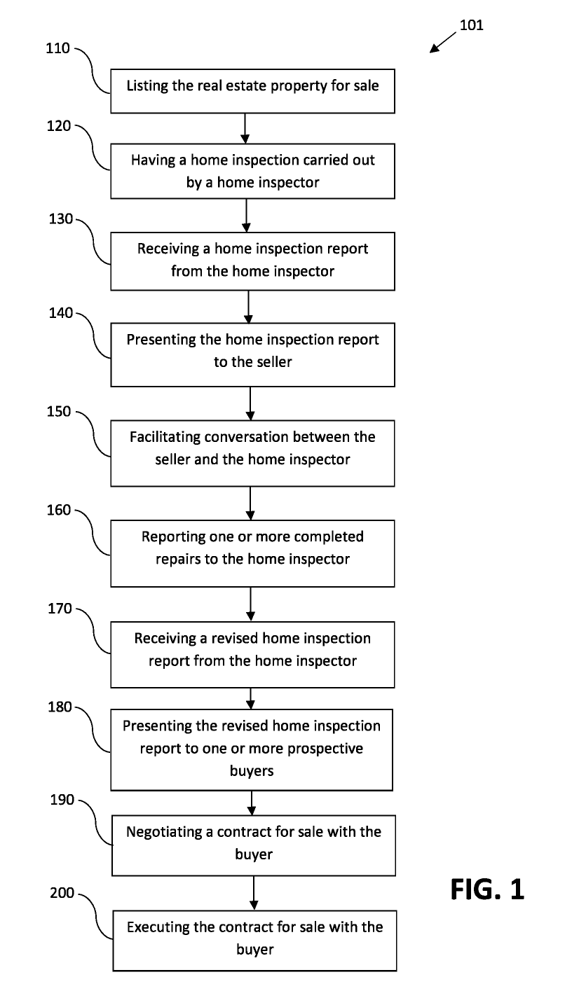

Referring to FIG. 1, process 101 for transferring a real estate property from a seller to a buyer includes step 110 listing the real estate property for sale, and then step 120 having a home inspection carried out by a home inspector, wherein the home inspector is paid by the seller. Throughout process 101, a seller may alternatively be referred to as a conveying party or an owner of the real estate property. Similarly, a buyer may alternatively be referred to as a receiving party or a buyer of the real estate property. Step 120 may include the possibility of the seller's real estate agent paying the home inspector, as opposed to the seller directly paying the home inspector.

After the home inspector has completed his or her home inspection of the real estate property, and created a home inspection report detailing a condition of the real estate property, the seller's real estate agent (or the seller's real estate agent's firm) receives the home inspection report from the home inspector, as is illustrated in step 130 of process 101. After receiving the home inspection report in step 130, step 140 involves the seller's real estate agent presenting the home inspection report to the seller. In this way, the seller may be informed of any real estate property deficiencies and thus, surprise deficiencies at a later buyer inspection are reduced or eliminated. Step 150 involves the seller's real estate agent facilitating conversation between the seller and the home inspector. Step 150 may include the seller's real estate agent getting the seller and the home inspector together (in person, by phone, or through electronic communication, for example) so as to allow the seller to speak with the inspector regarding any contents of the home inspection report. Step 150 may include the seller informing the home inspector that the seller believes the home inspector made an error in the home inspection report, and may include the home inspector editing the home inspection report in light of the conversation with the seller. Alternatively, or concurrently, the home inspector or the seller real estate agent may, during step 150, inform the seller of ways that the seller may alleviate one or more real estate property deficiencies detailed in the home inspection report. Step 150 may include an opportunity for the seller to alleviant these deficiencies, and then may also include the home inspector editing the home inspection report based upon the seller's alleviation of the deficiencies.

Process 101 includes step 160 reporting one or more completed repairs to the home inspector. After the seller has had an opportunity to discuss the home inspection report with the home inspector, as facilitated by step 150, the seller may have an opportunity to complete one or more repairs that were suggested by, or implied by, a condition of the real estate property as described in the home inspection report. For example, if the home inspection report includes a statement regarding high levels of radon gas, the seller may then alleviate the radon gas problem through one or more repairs. The one or more completed repairs may include an improvement or installation of an appliance or another piece of equipment. After one or more repairs are completed, process 101 step 160 involves reporting the one or more completed repairs to the home inspector. The reporting may involve notifying the home inspector of the one or more repairs via a letter, an electronic communication such as an email or text (SMS), a telephone conversation, or a meeting with the home inspector.

Process 101 includes step 170 receiving a revised home inspection report from the home inspector. After the one or more completed repairs are reported to the home inspector, the home inspector may then have an opportunity to revise the home inspection report in light of the one or more completed repairs reported to the home inspector. For example, if the home inspection report included a notation regarding a non-functioning lawn-watering sprinkler system, the seller may complete a repair to fix the lawn-watering sprinkler system, this completed repair may be reported to the home inspector, and then the home inspector may revise the home inspection report to create a revised home inspection report wherein the revised home inspection report no longer includes a notation regarding the non-functioning lawn-watering system. Step 170 includes receiving a revised home inspection report from the home inspector, wherein the revised home inspection report has been created in light of the one or more completed repairs reported to the home inspector.

Process 101 further includes step 180 presenting the revised home inspection report to one or more prospective buyers. A prospective buyer is a person in the process of looking for a home to buy, but who has not yet executed a contract for sale of the particular real estate property owned by the seller. Step 180 may include making copies (electronic or hardcopy, for example) of the revised home inspection report for distribution to prospective buyers, or may include making the revised home inspection report otherwise available to prospective buyers—such as by posting online, for example, or posting at the real estate property, in another example.

Process 101 further includes step 190 negotiating a contract for sale with the buyer. As herein disclosed, Step 190 may be greatly improved over prior art steps involving negotiating a contract for sale with the buyer, because both the seller and the buyer (or the prospective buyer) may take information contained within the revised home inspection report into account at the time of negotiating the contract for sale.

Process 101 may end with step 200 executing the contract for sale with the buyer. Similarly to step 190, both buyers and sellers can feel improved confidence at step 200 because both the buyer and the seller already know the contents of the home inspection report and thus already know a great deal about the condition of the real estate property based upon the qualified opinion of the home inspector.

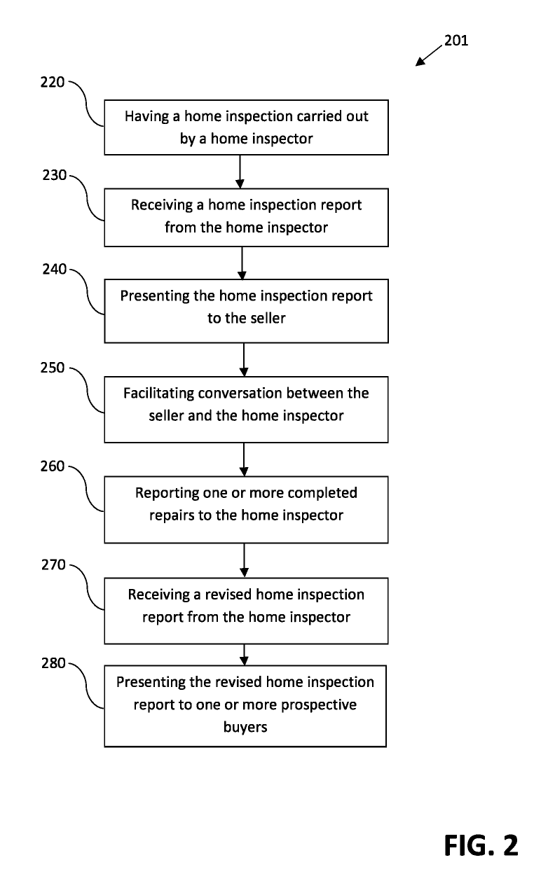

An alternative embodiment of the process is illustrated in FIG. 2 as process 201. Process 201 for conducting a post listing inspection of real estate property may comprise step 220 having a home inspection carried out by a home inspector; step 230 receiving a home inspection report from the home inspector; step 240 presenting the home inspection report to the seller; step 250 facilitating conversation between the seller and the home inspector; step 260 reporting one or more completed repairs to the home inspector; step 270 receiving a revised home inspection report from the home inspector; and step 280 presenting the revised home inspection report to one or more prospective buyers.

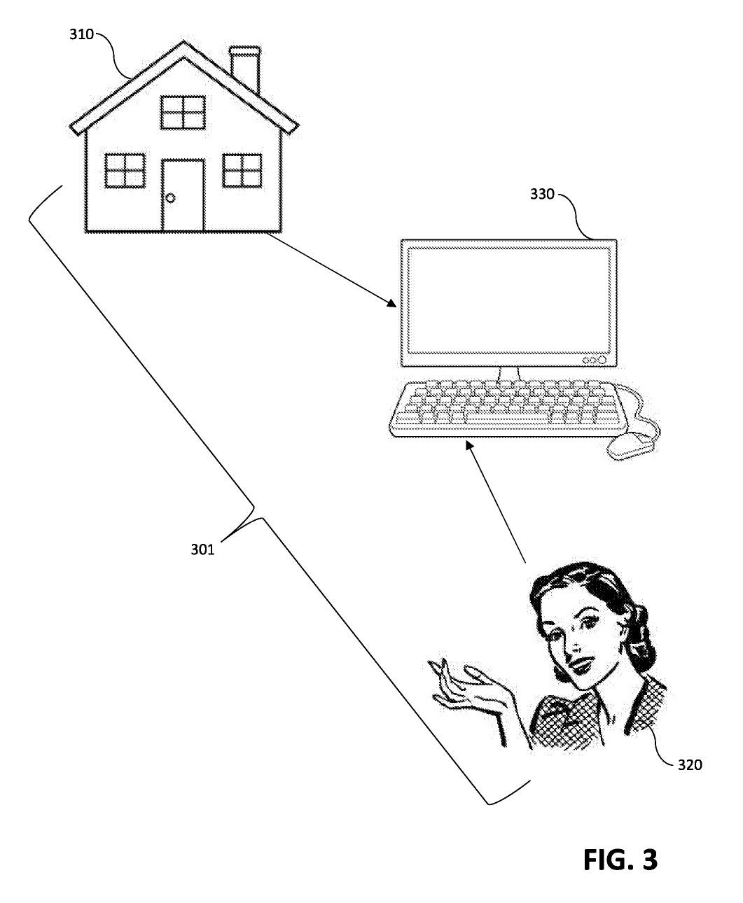

The process for transferring a real estate property, and alternative embodiments of the herein disclosed processes, may be carried out by a system for transferring a real estate property from a seller to a buyer comprising a website, a computer system, a mobile application, or an alternative digital structure for automating one or more of the herein disclosed process steps for conducting a post listing inspection of the real estate property. Such systems are intended to be included herein, and an exemplary system is illustrated in FIG. 3. For example, a website or a computer program may be provided that, once prompted by a seller's real estate agent working with a seller, may automatically set up a home inspection (perhaps with a home inspector that is contracted to regularly work with the seller's real estate agent or seller's real estate agent's firm) and may automatically receive the home inspection report, the revised home inspection report, and automatically present the home inspection report and/or the revised home inspection report to the seller via electronic communication. In this way, one or more of the steps of process 101 may be automated, as is known in the art. System 301 for conducting a post listing inspection of real estate property may include real estate property 310, real estate agent 320, and a real estate agent digital platform 330. Real estate agent digital platform 330 may be a website, a computer program, and/or a downloadable mobile application that is capable of electronically communicating with the real estate agent and that can automate one or more of the steps of process 101 or process 201 disclosed herein. For example, the system may automate a process to aggregate and evaluate estimated costs of repairs with areas identified for repair in home inspection. The herein disclosed system may alternatively be described as including a real estate agent digital platform that capable of electronic communication with a real estate agent and a home inspector.

The herein disclosed processes and systems for transferring a real estate property from a seller to a buyer may alternatively be referred to as processes and systems for conducting a post listing inspection of real estate property, or as processes and systems for conducting a post listing inspection of a seller's real estate property.

The disclosed processes and systems provide many advantages to a seller, to the seller's real estate agent, to the buyer, and to the home inspector. For example, the seller may, as part of step 120, have the home inspection scheduled at the seller's convenience (as opposed to at the buyer's convenience, as is the case for prior art buyer's inspections). Also, the seller can be alerted to any item of immediate concern regarding the condition of the real estate property (such as radon gas or active termite infestation, for example), as part of step 130. The seller may be able to assist the home inspector during the inspection, during step 120, something not normally possible during a prior art buyer's inspection. The seller may be provided with an opportunity to have the home inspector edit, or correct, any misstatements in the home inspection report, as described herein in reference to step 150. The seller may be able to adjust the sale price of the real estate property, in light of any insights available from receiving the home inspection report from the home inspector during step 130. For example, if substantial deficiencies are uncovered during the home inspection, the seller may lower the sale price. Or, if no deficiencies are uncovered, the seller may be able to effectively increase the sale price because the seller will be armed with the home inspection report detailing the prime condition of the real estate property. Revealing deficiencies to the seller at an earlier point in time may also allow the seller to make repairs and shop for competitive contractors, permit the seller to attach repair estimates or paid invoices to the home inspection report, and may remove over-inflated buyer-procured estimates from the negotiating table. Further, the home inspection report may alert both the seller and the seller's real estate agent to any safety issues within the real estate property, before any buyer agents, buyers, or visitors tour the real estate property. And, the revised home inspection report can provide full disclosure to prospective buyers, increasing confidence, lowering the chance for last-minute problems, and protecting against future legal claims.

The herein disclosed processes and systems may have additional benefits to the seller's real estate agent. For example, the seller's real estate agent can procure or recommend preferred certified home inspectors, as opposed to being at the mercy of the buyer's choice of home inspectors. Further, a post listing home inspection report can help a seller's real estate agent to have difficult conversations with the seller as to repairs that are necessary. Armed with such a home inspection report, the seller's real estate agent is more easily able to convey information that the seller is not excited to hear, such as the need for expensive repairs. And clean revised home inspection reports can be used by the real estate agent to market the home, thus driving interest from prospective buyers who may be encouraged by the possibility of viewing such a clean home before touring the real estate property.

The herein disclosed processes and systems may have additional benefits to the buyer. For example, the inspection is done and paid for, as opposed to prior art processes that may require the buyer to find a home inspector and pay for the home inspection of the real estate property. Further, the revised home inspection report may assist a buyer in acquiring financing to purchase the real estate property. And the presence of an already complete home inspection provides the seller another tool in the seller's negotiating arsenal, in that the buyer may offer to waive the post-contract for sale inspection in lieu of actually offering a higher sale price and thus offering additional value to the seller without actually raising the sale price.

The herein disclosed processes and systems may have additional benefits to the home inspector. For example, the timing of the herein disclosed process may allow home inspectors to acquire inspection jobs upstream, ahead of negotiated contracts for sale, thus allowing the home inspector to avoid increased competition. Under this disclosed process, a home inspector is under less time constraints and is working for the seller, and thus under less pressure generally than working for a buyer after the contract for sale. Further, a seller can alert home inspectors to problems that should be included in the report, answer questions about the real estate property, and provide seller's disclosure statements. Re-inspections may be less frequently required than under prior art post-contract for sale inspections. Distributed copies of the revised home inspection report (to prospective buyers and prospective buyer's real estate agents) can act as marketing for the home inspector. Liability for a home inspector may be reduced because additional time is provided for between the date of inspection and the move-in date for the buyer, and because the seller moving out of the real estate property is the home inspector's client, as opposed to the buyer moving into the real estate property.

While the present invention has been illustrated and described herein in terms of a preferred embodiment and several alternatives, it is to be understood that the apparatus described herein can have a multitude of additional uses and applications. Accordingly, the invention should not be limited to just the particular description and various drawing figures contained in this specification that merely illustrate a preferred embodiment and application of the principles of the invention.

What is claimed is:

1. A process for transferring a real estate property from a seller to a buyer, comprising the steps of:
listing the real estate property for sale;
having a home inspection carried out by a home inspector;
receiving a home inspection report from the home inspector, wherein the home inspection report is prepared by the home inspector based upon the home inspection;
presenting the home inspection report to the seller;
facilitating conversation between the seller and the home inspector;
reporting one or more completed repairs to the home inspector;
receiving a revised home inspection report from the home inspector, wherein the revised home inspection report is prepared by the home inspector based upon the home inspection report and the one or more completed repairs;
presenting the revised home inspection report to one or more prospective buyers;
negotiating a contract for sale with the buyer; and
executing the contract for sale with the buyer.

2. The process for transferring a real estate property from a seller to a buyer as recited in claim 1, wherein the step of having a home inspection carried out by a home inspector includes the seller paying the home inspector.

3. The process for transferring a real estate property from a seller to a buyer as recited in claim 1, wherein the step of having a home inspection carried out by a home inspector includes paying the home inspector.

4. The process for transferring a real estate property from a seller to a buyer as recited in claim 1, wherein the home inspection report includes a condition of the real estate property.

5. The process for transferring a real estate property from a seller to a buyer as recited in claim 1, wherein the step of facilitating conversation between the seller and the home inspector includes providing an opportunity for the seller to communicate with the home inspector regarding any contents of the home inspection report.

6. The process for transferring a real estate property from a seller to a buyer as recited in claim 1, wherein the step of facilitating conversation between the seller and the home inspector includes the home inspector informing the seller of one or more ways that the seller may alleviate one or more real estate property deficiencies included in the home inspection report.

7. The process for transferring a real estate property from a seller to a buyer as recited in claim 4, wherein the step of facilitating conversation between the seller and the home inspector includes providing an opportunity for the seller to complete one or more repairs suggested by the condition of the real estate property.

8. The process for transferring a real estate property from a seller to a buyer as recited in claim 1, wherein the step of facilitating conversation between the seller and the home inspector includes providing an opportunity for the seller to complete one or more repairs suggested by the home inspection report.

9. The process for transferring a real estate property from a seller to a buyer as recited in claim 1, wherein the step of receiving a revised home inspection report from the home inspector includes the step of the home inspector revising the home inspection report in light of the one or more completed repairs reported to the home inspector.

10. The process for transferring a real estate property from a seller to a buyer as recited in claim 1, wherein the step of presenting the revised home inspection report to one or more prospective buyers includes posting the revised home inspection report online.

11. The process for transferring a real estate property from a seller to a buyer as recited in claim 1, wherein the step of presenting the revised home inspection report to one or more prospective buyers includes posting the revised home inspection report at the real estate property.

12. The process for transferring a real estate property from a seller to a buyer as recited in claim 1, wherein the step of negotiating a contract for sale with the buyer includes utilizing the revised home inspection report to inform both the buyer and the seller.

13. The process for transferring a real estate property from a seller to a buyer as recited in claim 1, wherein the step of receiving a home inspection report from the home inspector includes the step of alerting the seller of any items of immediate concern regarding the real estate property.

14. The process for transferring a real estate property from a seller to a buyer as recited in claim 1, wherein the step of listing the real estate property for sale includes agreeing to a listing price and wherein the process further comprising the step of providing an opportunity for the seller to adjust the listing price based upon the home inspection report.

15. A system for transferring a real estate property from a seller to a buyer, comprising:
the real estate property, wherein the seller owns the real estate property;
real estate agent for listing the real estate property for sale at a sale price; and
a real estate agent digital platform for automatically having a home inspection carried out by a home inspector; automatically receiving a home inspection report from the home inspector; automatically presenting the home inspection report to the seller; receiving one or more completed repairs from the seller; automatically reporting the one or more completed repairs to the home inspector; receiving a revised home inspection report from the home inspector; and automatically presenting the revised home inspection report on the real estate agent digital platform.

16. The system for transferring a real estate property from a seller to a buyer as recited in claim 15, wherein the real estate agent digital platform includes a website.

17. The system for transferring a real estate property from a seller to a buyer as recited in claim 15, wherein the real estate agent digital platform includes a mobile application downloadable onto mobile computing devices.

18. A process for conducting a post listing inspection of real estate property, comprising the steps of:
having a home inspection carried out by a home inspector;
receiving a home inspection report from the home inspector, wherein the home inspection report is prepared by the home inspector based upon the home inspection;
presenting the home inspection report to the seller;
facilitating conversation between the seller and the home inspector;
reporting one or more completed repairs to the home inspector;
receiving a revised home inspection report from the home inspector, wherein the revised home inspection report is prepared by the home inspector based upon the home inspection report and the one or more completed repairs; and
presenting the revised home inspection report to one or more prospective buyers.

19. The process for transferring a real estate property from a seller to a buyer as recited in claim 18, wherein the step of facilitating conversation between the seller and the home inspector includes the home inspector informing the seller of one or more ways that the seller may alleviate one or more real estate property deficiencies included in the home inspection report.

20. The process for transferring a real estate property from a seller to a buyer as recited in claim 18, wherein the step of having a home inspection carried out by a home inspector includes the seller paying the home inspector.
